(19) United States
(12) Patent Application Publication
(10) Pub. No.: US 2008/0022396 A1
(43) Pub. Date: Jan. 24, 2008

(54) Memory data protection device and IC card LSI

(76) Inventor: Kazunori Kado, Osaka (JP)

Correspondence Address: MCDERMOTT WILL & EMERY LLP, 600 13TH STREET, NW, WASHINGTON, DC, 20005-3096, US

(21) Appl. No.: 11/802,799

(22) Filed: May 25, 2007

(30) Foreign Application Priority Data
May 30, 2006 (JP) 2006-149781

(51) Int. Cl. G06F 12/14

(52) U.S. Cl. 726/19

(57) ABSTRACT

An unauthorized access redirection area is provided in a memory space, and a physical address is assigned to the unauthorized access redirection area. It is determined in an access authority determination section and an access permission/denial determination circuit whether the access to security data by an executable program to be executed by the CPU is an authorized access or an unauthorized access. If it is determined that the access is an unauthorized access, the mapping of the logical address of the security data to be accessed is changed to the physical address assigned to the unauthorized access redirection area. Then, a data operation is performed in the unauthorized access redirection area to which the access is redirected by changing the mapping. Thus, it is possible to provide a memory data protection device capable of protecting the security data, while preventing an ill-willed person from identifying the location of an important data area storing the security data when there is an unauthorized access.

### CROSS REFERENCE TO RELATED APPLICATIONS

This Non-provisional application claims priority under 35 U.S.C. §119(a) on Patent Application No. 2006-149781 filed in Japan on May 30, 2006, the entire contents of which are hereby incorporated by reference.

### BACKGROUND OF THE INVENTION

The present invention relates to a memory data protection device and an IC card LSI with an enhanced security function, wherein an access control is provided for a memory storing security data such as an LSI used in an IC card.

IC card LSIs having a memory storing security data are used in applications such as electronic tickets and credit cards.

An IC card LSI typically includes a ROM for storing an application or a control program, an SRAM for temporarily storing data produced during operation, and a non-volatile memory capable of holding data therein even after the power supply is cut off. These memories store privacy information and data such as money information, and it is important to ensure security thereof.

A conventional semiconductor integrated circuit with an enhanced security function is disclosed in Japanese Laid-Open Patent Publication No. 2005-25340. With this technique, a range of addresses of a memory is prescribed as a read-prohibited area or a write-prohibited area. When there is a type of access to an area that is prohibited for that area, the production of a memory access control signal is prohibited to thereby disable access to the memory, thus ensuring security.

With the technique disclosed in Japanese Laid-Open Patent Publication No. 2005-25340, memory access is disabled by prohibiting the production of an access control signal. Therefore, when there is an unauthorized access such as an unauthorized read or an unauthorized write, the data read operation or the data write operation from/to the memory is not performed. However, one may possibly determine that the protected memory area is an important data area storing security data, thus identifying the location of the important data area. Once the location of the important data area is identified, security data stored in the memory may be altered by probing the memory, and the LSI may be illicitly powered and analyzed. Thus, it cannot be said that the data is kept securely.

### SUMMARY OF THE INVENTION

It is an object of the present invention to provide a memory data protection device capable of protecting security data, wherein even the location of the important data area storing the security data cannot be identified even if there is an unauthorized access.

In order to achieve the object set forth above, when there is an unauthorized access, the device of the present invention does not access the important data area storing security data, but instead accesses a totally different area, erases the security data itself, or externally report the unauthorized access after the unauthorized access.

Specifically, a memory data protection device of the present invention is a memory data protection device for protecting security data in a memory from leakage for use in a semiconductor integrated circuit including: the memory storing the security data; a ROM storing a program with access authority to the security data in the memory and a program without the access authority; and a CPU executing a program in the ROM, the memory data protection device including: an access authority determination section for determining whether an executable program to be executed by the CPU is authorized to access the security data in the memory; an access permission/denial determination section for determining whether the executable program can access the security data in the memory based on a determination result from the access authority determination section and a logical address of the data to be accessed by the executable program; and a mapping changing section for changing mapping of the logical address of the security data to be accessed to an area in a memory space that is different from an area where the security data is stored, when the access to the security data in the memory by the executable program is denied by the access permission/denial determination section.

In one embodiment of the present invention, the security data in the memory is stored in an access-limited area to which an access is limited from a program without the access authority to the security data.

In one embodiment of the present invention, the mapping changing section changes the mapping of the logical address of the security data stored in the access-limited area of the memory to a physical address of data stored in a non-access-limited area outside the access-limited area.

In one embodiment of the present invention, an unauthorized access redirection area is provided in a memory space, and a physical address is assigned to the unauthorized access redirection area; and the mapping changing section changes the mapping of the logical address of the security data stored in the memory to the physical address of the unauthorized access redirection area.

In one embodiment of the present invention, an unauthorized access redirection register is provided in a memory space, and a physical address is assigned to the unauthorized access redirection register; and the mapping changing section changes the mapping of the logical address of the security data stored in the memory to the physical address of the unauthorized access redirection register.

In one embodiment of the present invention, the memory data protection device further includes: a wait circuit for delaying an output of a signal for a predetermined amount of time; and a random number generating circuit for generating a random number of a predetermined bit width, wherein: if the access to the security data in the memory by the executable program is a read operation access, the mapping changing section outputs to the CPU a random number generated by the random number generating circuit; and if the access to the security data in the memory by the executable program is a write operation access, the mapping changing section outputs to the CPU an acknowledge signal delayed by the wait circuit according to a timing of a memory control signal output from the CPU.

In one embodiment of the present invention, the memory data protection device further includes: a wait circuit for delaying an output of a signal for a predetermined amount of time; and a dummy data area in the ROM storing dummy data, wherein: if the access to the security data in the memory by the executable program is a read operation access, the mapping changing section changes the mapping of the logical address of the security data stored in the memory to a physical address of the dummy data area to output to the CPU the dummy data in the dummy data area; and if the access to the security data in the memory by the executable program is a write operation access, the mapping changing section outputs to the CPU an acknowledge signal delayed by the wait circuit according to a timing of a memory control signal output from the CPU.

A memory data protection device of the present invention is a memory data protection device for protecting security data in a memory from leakage for use in a semiconductor integrated circuit including: the memory storing the security data; a ROM storing a program with access authority to the security data in the memory and a program without the access authority; and a CPU executing a program in the ROM, the memory data protection device including: an access authority determination section for determining whether an executable program to be executed by the CPU is authorized to access the security data in the memory; an access permission/denial determination section for determining whether the executable program can access the security data in the memory based on a determination result from the access authority determination section and a logical address of the data to be accessed by the executable program; and a data altering section for overwriting the security data to be accessed to predetermined data or erasing the security data to be accessed when the access to the security data in the memory by the executable program is denied by the access permission/denial determination section.

A memory data protection device of the present invention is a memory data protection device for protecting security data in a memory from leakage for use in a semiconductor integrated circuit including: the memory storing the security data; a ROM storing a program with access authority to the security data in the memory and a program without the access authority; and a CPU executing a program in the ROM, the memory data protection device including: an access authority determination section for determining whether an executable program to be executed by the CPU is authorized to access the security data in the memory; an access permission/denial determination section for determining whether the executable program can access the security data in the memory based on a determination result from the access authority determination section and a logical address of the data to be accessed by the executable program; an unauthorized access storing section for storing an unauthorized access when the access to the security data in the memory by the executable program is denied by the access permission/denial determination section; and an unauthorized access notification section for notifying the unauthorized access stored in the unauthorized access storing section to outside.

In one embodiment of the present invention, the unauthorized access storing section is an unauthorized access count storing area provided in the memory; and the unauthorized access notification section notifies the unauthorized access stored in the unauthorized access count storing area to outside when a comparison between an unauthorized access count stored in the unauthorized access count storing area with an unauthorized access upper-limit count stored in the memory indicates that the unauthorized access count is greater than or equal to the unauthorized access upper-limit count.

An IC card LSI of the present invention is an IC card LSI provided in an IC card, including a memory data protection device as set forth above.

Thus, according to the present invention, when an executable program executed by the CPU is not authorized to access security data in the memory and the executable program is attempting to access the security data, the mapping of the logical address of the security data to be accessed by the executable program is changed to an area of the memory space different from the security data. Therefore, the executable program does not access the security data but accesses the different area to which the access is redirected after the mapping is changed, thus disabling the access to the security data. Since read and write operations are performed after changing the mapping, it is possible to prevent an ill-willed person from identifying the location of an important data area storing security data.

According to the present invention, when an executable program executed by the CPU is not authorized to access security data in the memory and the executable program is attempting to access the security data, the security data to be accessed by the executable program is erased from the memory or altered, thus disabling the access to the security data itself. Moreover, since the security data itself is erased or altered, it is possible to prevent an ill-willed person from identifying the location of an important data area storing security data.

According to the present invention, when an executable program executed by the CPU is not authorized to access security data in the memory and the executable program is attempting to access the security data, the unauthorized access is stored, and the stored unauthorized access is notified to the outside so as to disable the exchange of data between the memory data protection device and the outside. Thus, it is possible to reliably control the access to security data.

### BRIEF DESCRIPTION OF THE DRAWINGS

FIG. 1 is a flow chart showing a general process flow of a memory data protection method for a memory data protection device according to a first embodiment of the present invention.

FIG. 2 is a schematic diagram showing a memory space of the memory data protection device.

FIG. 3 is a block diagram showing a general configuration of the memory data protection device.

FIG. 4 is a block diagram showing a general configuration of a memory data protection device according to a second embodiment of the present invention.

FIG. 5 is a block diagram showing a general configuration of a memory data protection device according to a third embodiment of the present invention.

FIG. 6 is a block diagram showing a general configuration of a memory data protection device according to a fourth embodiment of the present invention.

FIG. 7 is a flow chart showing a general process flow of a memory data protection method for a memory data protection device according to a fifth embodiment of the present invention.

FIG. 8 is a block diagram showing a general configuration of the memory data protection device.

FIG. 9 is a block diagram showing a general configuration of a memory data protection device according to a sixth embodiment of the present invention.

FIG. 10 is a block diagram showing a general configuration of a memory data protection device according to a seventh embodiment of the present invention.

### DETAILED DESCRIPTION OF THE INVENTION

Preferred embodiments of the present invention will now be described with reference to the accompanying drawings.

### Embodiment 1

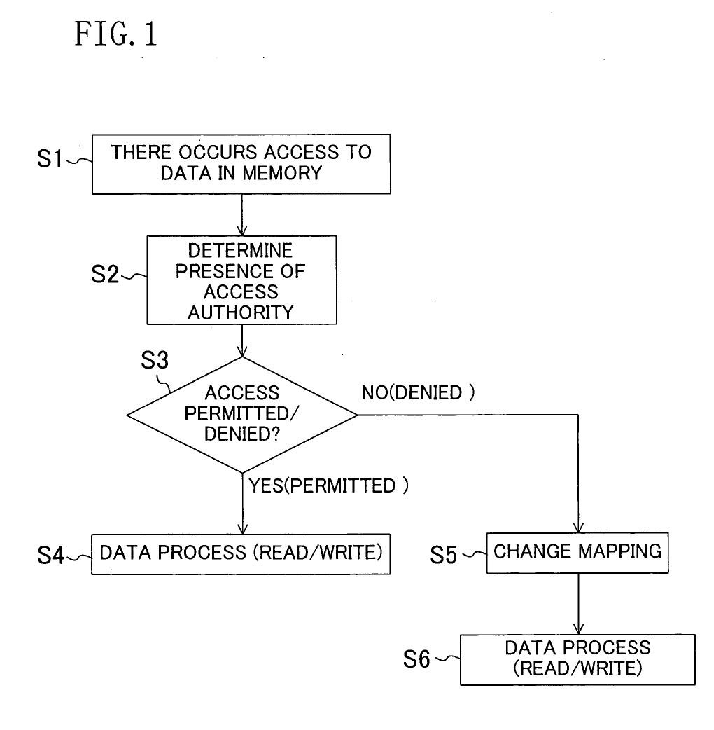

FIG. 1 shows a general process flow of a memory data protection method for a memory data protection device according to a first embodiment of the present invention.

Referring to FIG. 1, when there is an access to data in a memory from an executable program to be executed by a CPU (step S1), the process determines the access authority of the executable program for accessing security data in the memory (step S2). The ROM provided in the memory data protection device of the present invention stores API programs such as libraries with access authority to security data, and OS programs such as applications without access authority. In step S2, the process determines the access authority by determining whether the executable program read out from the ROM by the CPU is an API program or an OS program.

The process determines whether access shall be permitted to the data to be accessed by the executable program, based on the access authority of the executable program as determined in step S2 and the logical address of the data to be accessed by the executable program in the memory (step S3). If the data to be accessed is data other than security data, the access to the data is permitted, irrespective of the access authority of the executable program. Where the data to be accessed is security data, the access to the security data is permitted if the executable program has access authority. If the executable program has no access authority, the access from the executable program is determined to be an unauthorized access and the access to the security data is denied.

If it is determined in step S3 that the access shall be permitted, the logical address of the data to be accessed by the executable program is mapped to the physical address of the data, and a data operation such as a read operation or a write operation is performed (step S4).

If it is determined in step S3 that the access shall be denied, mapping is changed so that the logical address of the security data to be accessed by the executable program is mapped to an area of the memory space different from the security data (step S5). Then, a data operation such as a read operation or a write operation is performed on data obtained after the mapping is changed (step S6).

In the process flow of steps S1 to S6, the process controls the access to data in the memory based on the access authority of the executable program to be executed by the CPU for security data, and whether the data to be accessed by the executable program is security data.

When there is an unauthorized access to security data in the memory, mapping to the physical address of the security data is changed, and a data operation is performed on data obtained after the mapping is changed. Therefore, it is possible to reliably realize an access control for security data stored in the memory. Since a read operation or a write operation is actually performed after the mapping is changed, it is possible to prevent one from identifying the location of the memory area storing the security data, thus more reliably protecting the security data.

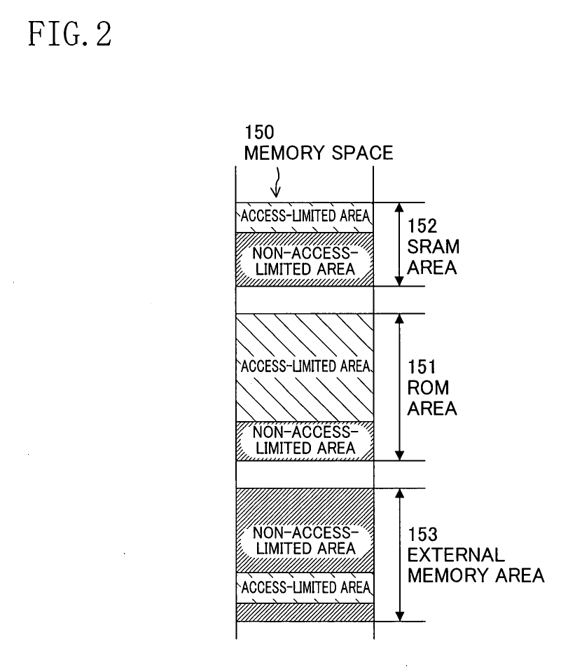

FIG. 2 is a schematic diagram showing a memory space of the memory data protection device of the present embodiment.

Referring to FIG. 2, where a ROM, an SRAM (the memory) and a non-volatile memory (the memory) are provided in the memory data protection device, a memory space 150 includes a ROM area 151, an SRAM area 152 and an external memory area 153, corresponding to the ROM, the SRAM and the non-volatile memory, respectively, and each area is assigned a physical address.

The SRAM and the non-volatile memory, which are memories, store security data, wherein the security data is stored in an access-limited area to which access is limited from a program without access authority to the security data, i.e., an executable program in the OS program area of the ROM. Data that can be accessed by an executable program in the ROM irrespective of the access authority to the security data is stored in a non-access-limited area, outside the access-limited area. As with the SRAM and the non-volatile memory, the ROM is also divided into an access-limited area and a non-access-limited area depending on the access authority to data in the ROM.

An access-limited area or a non-access-limited area does not need to be assigned a continuous block of physical addresses as shown in the figure, but may of course be assigned non-continuous physical addresses.

The memory data protection device of the present invention to be described below in detail is a memory data protection device capable of protecting security data stored in the SRAM and the non-volatile memory from leakage.

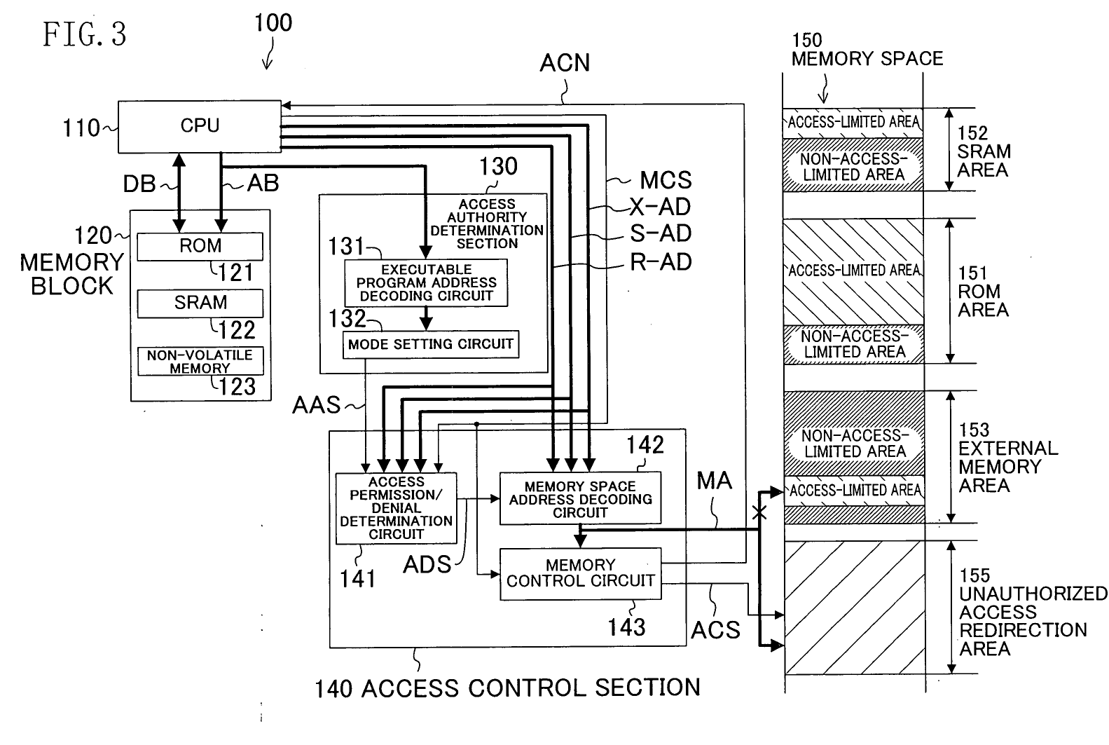

FIG. 3 is a block diagram showing a general configuration of the memory data protection device of the present embodiment.

Referring to FIG. 3, a memory data protection device 100 includes a CPU 110, a memory block 120, an access authority determination section 130 and an access control section 140. The memory block 120 includes a ROM 121, an SRAM (the memory) 122, and a non-volatile memory (the memory) 123. In the figure, R-AD is the logical address of data in the ROM 121, S-AD is the logical address of data in the SRAM 122, X-AD is the logical address of data in the non-volatile memory 123, and MCS is a memory control signal. Moreover, AB is a program address bus and DB is a program data bus, and the CPU 110 executes a program stored in the ROM 121 via the program address bus AB and the program data bus DB.

The access authority determination section 130 includes therein an executable program address decoding circuit 131 and a mode setting circuit 132. The access control section 140 includes therein an access permission/denial determination circuit (the access permission/denial determination section) 141, a memory space address decoding circuit (the mapping changing section) 142, and a memory control circuit 143.

As in FIG. 2, reference numeral 150 schematically represents the memory space of the memory data protection device of the present embodiment. The memory space 150 includes an unauthorized access redirection area 155, which is assigned a physical address. A predetermined random value is stored in the unauthorized access redirection area 155.

The operation of the memory data protection device of the present embodiment will now be described.

When the CPU 110 is to execute a program in the ROM 121, the logical address of the executable program is input to the access authority determination section 130 via the program address bus AB.

In the access authority determination section 130, the executable program address decoding circuit 131 decodes the logical address of the executable program into the physical address of the executable program. Then, the decoded physical address of the executable program is input to the mode setting circuit 132, and it is determined whether the executable program is an API program with access authority to the security data in the memories 122 and 123 or an OS program without access authority, thus outputting an access authority signal AAS to the access control section 140.

In the access control section 140, a memory control signal MCS, the access authority signal AAS and the logical addresses R-AD, S-AD and X-AD of the data to be accessed by the executable program are input to the access permission/denial determination circuit 141, and it is determined whether access should be allowed to data to be accessed by the executable program to thereby output an access permission/denial signal ADS.

In a case where the executable program is a program in the OS program area without access authority to the security data in the memories 122 and 123 and the executable program is to access the access-limited area of the memories 122 and 123, the access permission/denial determination circuit 141 outputs the access permission/denial signal ADS signal indicating that the access to security data by the executable program shall be denied. Otherwise, in a case where, for example, the executable program is a program in the OS program area and the executable program is to access data stored in the non-access-limited area in the memories 122 and 123, the access permission/denial determination circuit 141 outputs the access permission/denial signal ADS signal indicating that the access shall be permitted. If the access permission/denial signal ADS output from the access permission/denial determination circuit 141 indicates that access shall be denied, it is determined that the access to security data by the executable program is an unauthorized access.

The access permission/denial signal ADS output from the access permission/denial determination circuit 141 is input to a memory space address decoding circuit 142, and the mapping of the logical addresses R-AD, S-AD and X-AD of the data to be accessed by the executable program is performed based on the access permission/denial signal ADS.

If the access permission/denial signal ADS permits an access to the data to be accessed, the logical address of the data to be accessed is mapped to the physical address thereof, and the physical address of the data to be accessed by the executable program is output to the memory control circuit 143 as an access address MA. If the access to the data to be accessed is denied, the mapping of the logical address of the data to be accessed, i.e., security data in the access-limited area of the memories 122 and 123, is changed to the physical address of the unauthorized access redirection area 155 provided in the memory space 150, and the physical address of the unauthorized access redirection area 155 is output to the memory control circuit 143 as the access address MA.

Based on the memory control signal MCS and the access address MA output from the memory space address decoding circuit 142, the memory control circuit 143 outputs an access control signal ACS to the memory space 150 and performs data processing operations.

If the unauthorized access is a read operation access, the CPU 110 reads in a random value preset in the unauthorized access redirection area 155. If the unauthorized access is a write operation access, a value is stored in the unauthorized access redirection area 155 overwriting the existing value. Upon completion of the data read or write operation, the memory control circuit 143 outputs an acknowledge signal ACN to the CPU 110 to report the completion of the operation.

In FIG. 3, the executable program to be executed by the CPU 110 is an OS program and the OS program is attempting to access data in the access-limited area of the external memory area 153. However, it is determined by the access permission/denial determination circuit 141 that the access is an unauthorized access, whereby the access to the security data is denied. Accordingly, the access address MA is determined after the memory space address decoding circuit 142 changes the mapping of the logical address of the data to be accessed to the physical address assigned to the unauthorized access redirection area 155. Then, the memory control circuit 143 accesses the unauthorized access redirection area 155 to which the access is redirected after the mapping is changed.

The unauthorized access redirection area 155 is provided in the memory space 150, as described above. When there is an unauthorized access, the mapping of the logical address of the security data to be accessed by the executable program is changed to the physical address assigned to the unauthorized access redirection area 155. Thus, a read operation or a write operation is performed in the unauthorized access redirection area 155, whereby it is possible to reliably protect the security data from leakage without an ill-willed person identifying the location of the access-limited area storing the security data.

In the present embodiment, the unauthorized access redirection area 155 is provided in the physical memory space 150 so that any unauthorized access is mapped to the physical address of the unauthorized access redirection area 155. The security data in the memories 122 and 123 can also be protected from leakage by changing the mapping to the non-access-limited area of the memories 122 and 123 or the ROM 121.

### Second Embodiment

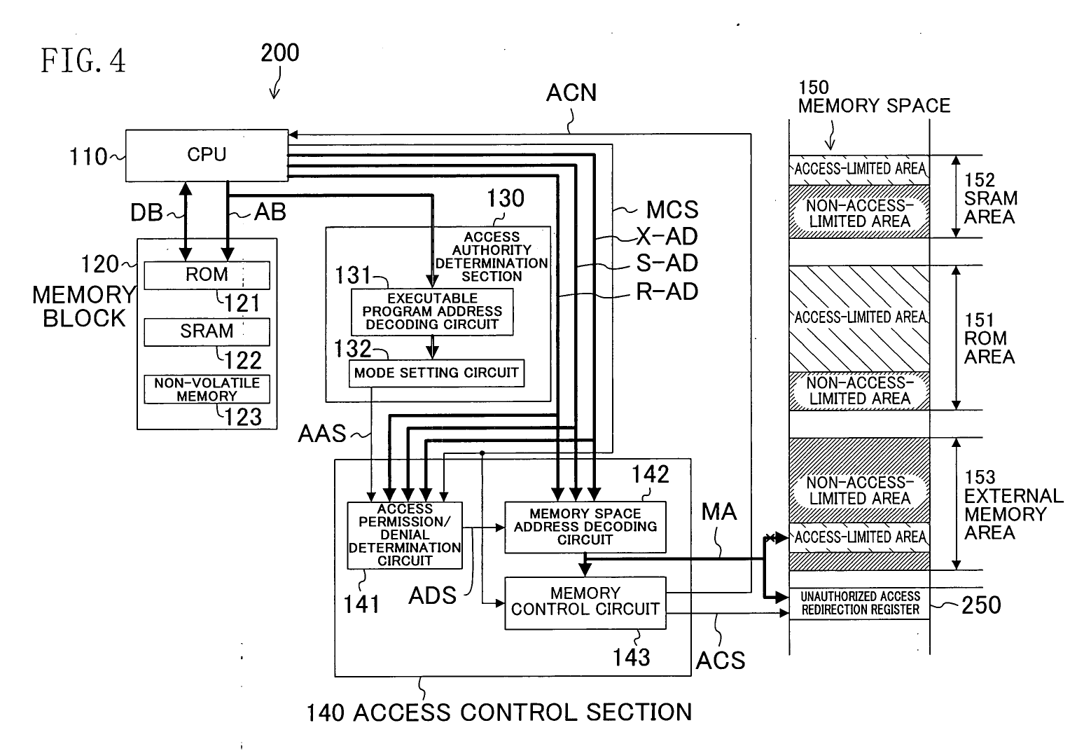

FIG. 4 is a block diagram showing a general configuration of a memory data protection device according to a second embodiment of the present invention.

A memory data protection device 200 of the present embodiment differs from the memory data protection device 100 of the first embodiment shown in FIG. 3 in that an unauthorized access redirection register 250 is provided in the memory space 150. Otherwise, the configuration is the same as that of the first embodiment, and will not be further described below.

A predetermined random value is stored in the unauthorized access redirection register 250 provided in the memory space 150. In a case where it is determined by the access permission/denial determination circuit 141 in the access control section 140 that the access is an unauthorized access, the memory space address decoding circuit 142 changes the mapping of the logical address of the security data to be accessed by the executable program to the physical address assigned to the unauthorized access redirection register 250, and the physical address of the unauthorized access redirection register 250 is output to the memory control circuit 143 as the access address MA.

The memory control circuit 143 outputs the access control signal ACS such that an access is made to the physical address of the unauthorized access redirection register 250, and a read operation or a write operation is performed on data in the unauthorized access redirection register 250 based on the access control signal ACS.

If the unauthorized access is a read operation access, the CPU 110 reads in a random value preset in the unauthorized access redirection register 250. If the unauthorized access is a write operation access, a value is stored in the unauthorized access redirection register 250 overwriting the existing value. Upon completion of the data read or write operation, the memory control circuit 143 outputs the acknowledge signal ACN to the CPU 110 to report the completion of the operation.

The unauthorized access redirection register 250 is provided in the memory space 150, as described above. When there is an unauthorized access, the physical address mapping is changed so that an access is made to the unauthorized access redirection register 250 before a read operation or a write operation is performed. Therefore, it is possible to reliably protect the security data without an ill-willed person identifying the location of the access-limited area in the memories 122 and 123.

In the present embodiment, only one unauthorized access redirection register 250 is provided. Therefore, only one physical address is needed for redirection of an unauthorized access, and the embodiment can be used with a CPU with a small memory space. Note however that the number of the unauthorized access redirection registers 250 is not limited to one.

### Third Embodiment

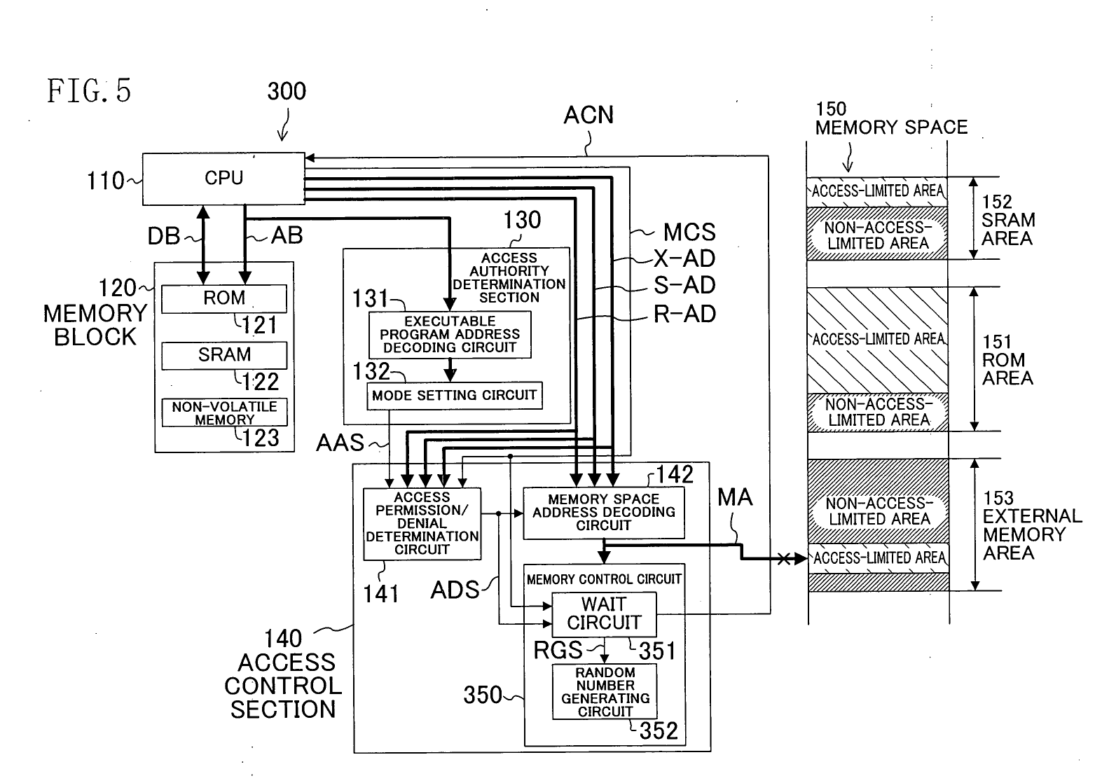

FIG. 5 is a block diagram showing a general configuration of a memory data protection device according to a third embodiment of the present invention.

A memory data protection device 300 of the present embodiment differs from the memory data protection device 100 of the first embodiment shown in FIG. 3 in that a wait circuit 351 and a random number generating circuit 352 are provided in a memory control circuit 350. Otherwise, the configuration is the same as that of the memory data protection device of the first embodiment, and will not be further described below.

If it is determined by the access permission/denial determination circuit 141 in the access control section 140 that the access is an unauthorized access, the memory space address decoding circuit 142 notifies the memory control circuit 350 of the logical address of the security data to be accessed by the executable program.

If the access to the security data from the executable program is a write operation access, the acknowledge signal ACN is returned to the CPU 110 after being delayed by the wait circuit 351 according to the amount of time required for a normal write operation access in view of the process time of the corresponding memory based on the memory control signal MCS input from the CPU 110 and the logical address of the security data to be accessed by the executable program input from the memory space address decoding circuit 142. Thus, the CPU 110 perceives that the write operation has been performed. If the access from the executable program is a read operation access, a random number generating signal RGS is output to the random number generating circuit 352 after being delayed by the wait circuit 351 according to the amount of time required for a normal read operation access in view of the process time of the corresponding memory based on the memory control signal MCS input from the CPU 110 and the logical address of the security data to be accessed by the executable program input from the memory space address decoding circuit 142. Then, the random number generated by the random number generating circuit 352 is returned to the CPU 110, which perceives that the read operation has been performed.

As described above, the wait circuit 351 and the random number generating circuit 352 are further provided, which make it look like a read operation or a write operation has actually been performed, whereby it is possible to reliably protect security data without an ill-willed person identifying the location of the access-limited area in the memories 122 and 123.

Moreover, a data operation is performed without changing the mapping to data in the memories 122 and 123, whereby it is possible to more reliably protect security data.

With the memory data protection device of the present embodiment, if there are a plurality of unauthorized read operation accesses to the same security data, the CPU 110 reads in data of a different value each time. In view of this, a random number storing section may be additionally provided for storing the value returned to the CPU 110 in response to an unauthorized read operation access, whereby the same value can always be returned to the CPU 110 in response to an unauthorized read access to the same security data.

The present embodiment can be realized without making any change to the memory space, and is therefore effective in cases where the memory space does not have much extra space.

### Fourth Embodiment

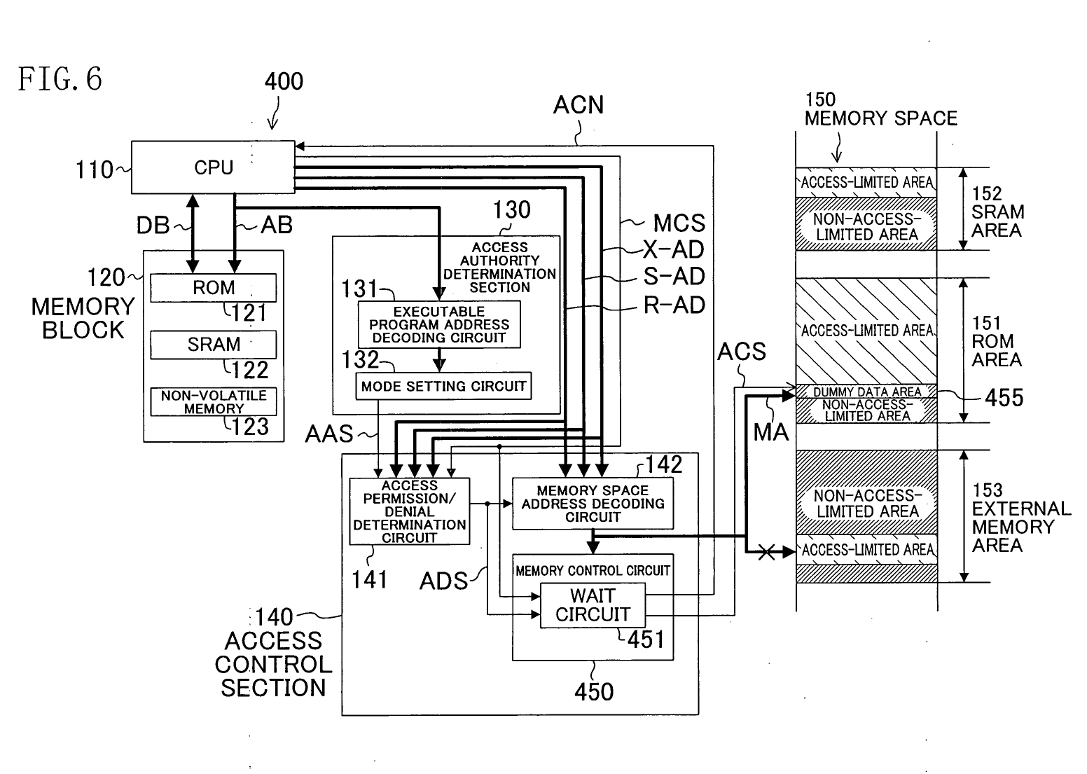

FIG. 6 is a block diagram showing a general configuration of a memory data protection device according to a fourth embodiment of the present invention.

A memory data protection device 400 of the present embodiment differs from the memory data protection device 300 of the third embodiment shown in FIG. 5 in that a dummy data area 455 is provided in the ROM 121. Otherwise, the configuration is the same as that of the third embodiment, and will not be further described below.

Predetermined dummy data is stored in the dummy data area 455 provided in the ROM 121. If it is determined by the access permission/denial determination circuit 141 in the access control section 140 that the access is an unauthorized access, and if the unauthorized access is a read operation access, the memory space address decoding circuit 142 changes the mapping of the logical address of security data to be accessed by the executable program to the physical address assigned to the dummy data area 455, whereby the physical address of the dummy data area 455 is output to a memory control circuit 450 as the access address MA. After receiving the access address MA, a wait circuit 451 in the memory control circuit 450 outputs the access control signal ACS, which is delayed according to the amount of time of a read operation access at the timing of the memory control signal MCS input from the CPU 110, and accesses the access address MA being the physical address of the dummy data area 455, to read out dummy data in the dummy data area 455.

If the access to security data from the executable program is a write operation access, the memory space address decoding circuit 142 outputs, to the memory control circuit 450, the logical address of the security data to be accessed by the executable program, as in the third embodiment, and the acknowledge signal ACN is returned to the CPU 110 after being delayed by the wait circuit 451 according to the amount of time of a write operation access.

As described above, the dummy data area 455 is provided in the ROM 121, and dummy data in the dummy data area 455 is read out when there is an unauthorized read access, whereby when there are a plurality of unauthorized read accesses, the same value can be returned to the CPU 110 in response to unauthorized read accesses to the same security data. By providing the dummy data area 455 in the free area of the ROM 121, the ROM 121 can be utilized efficiently.

### Fifth Embodiment

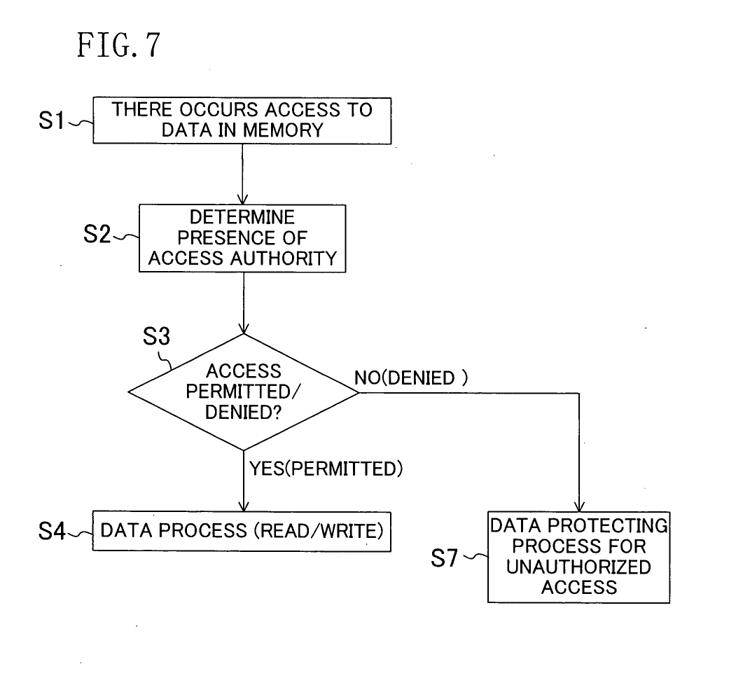

FIG. 7 shows a general process flow of a memory data protection method for a memory data protection device according to a fifth embodiment of the present invention.

In FIG. 7, steps S1 to S4 are the same as those in the flow chart of FIG. 1, and will not be further described below.

If it is determined in step S3 that the access shall be denied, memory data is protected by erasing the security data to be accessed by the executable program, or by storing and externally reporting the unauthorized access (step S7).

Through the above process, when there is an unauthorized access, the security data that the executable program has attempted to access is erased so as to disable access to the security data itself, or the stored unauthorized access is notified to the outside so as to disable the exchange of data between the memory data protection device and the outside. Thus, it is possible to reliably control the access to security data and to protect the security data.

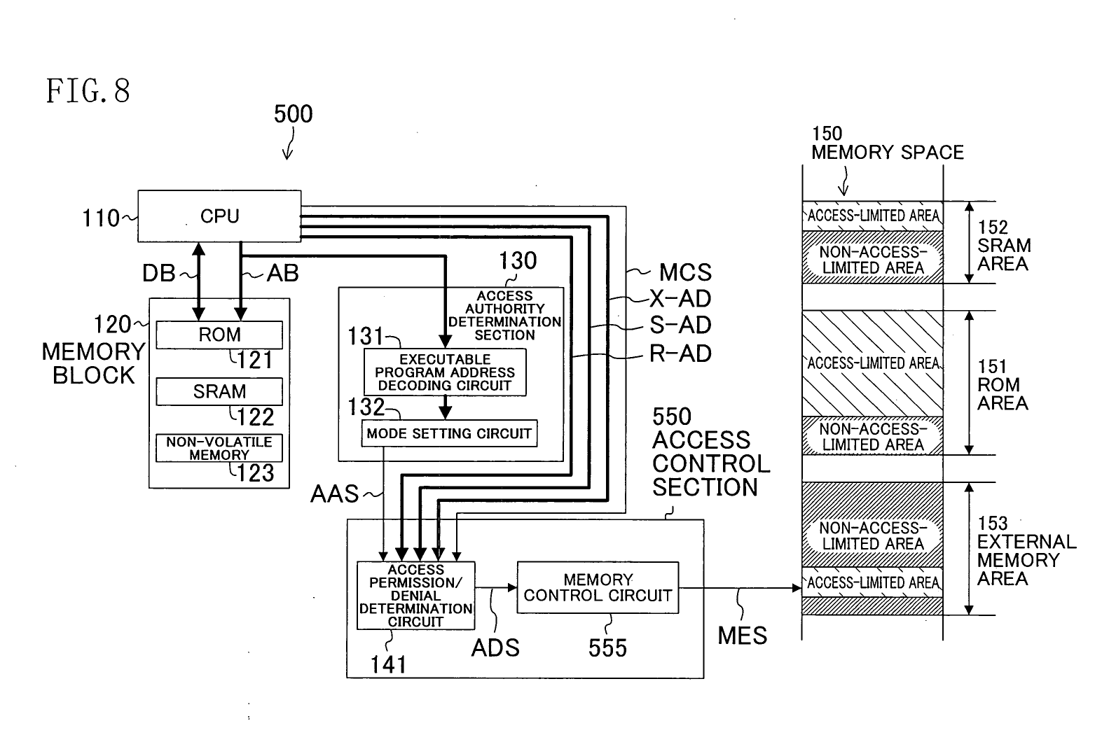

FIG. 8 is a block diagram showing a general configuration of the memory data protection device of the present embodiment.

Referring to FIG. 8, a memory data protection device 500 includes the CPU 110, the memory block 120, the access authority determination section 130, and an access control section 550. The memory block 120 includes the ROM 121, the SRAM (the memory) 122, and the non-volatile memory (the memory) 123. In the figure, R-AD is the logical address of data in the ROM 121, S-AD is the logical address of data in the SRAM 122, X-AD is the logical address of data in the non-volatile memory 123, and MCS is a memory control signal. Moreover, AB is a program address bus and DB is a program data bus, and the CPU 110 executes a program stored in the ROM 121 via the program address bus AB and the program data bus DB.

The access authority determination section 130 includes therein the executable program address decoding circuit 131 and the mode setting circuit 132. The access control section 550 includes therein the access permission/denial determination circuit (the access permission/denial determination section) 141, and a memory control circuit (the data altering section) 555.

The operation of the memory data protection device of the present embodiment will now be described.

When the CPU 110 is to execute a program in the ROM 121, the logical address of the executable program is input to the access authority determination section 130 via the program address bus AB.

In the access authority determination section 130, the executable program address decoding circuit 131 decodes the logical address of the executable program into the physical address of the executable program. Then, the decoded physical address of the executable program is input to the mode setting circuit 132, and it is determined whether the executable program is an API program with access authority to the security data in the memories 122 and 123 or an OS program without access authority, thus outputting an access authority signal AAS to the access control section 550.

In the access control section 550, the memory control signal MCS, the access authority signal AAS and the logical addresses R-AD, S-AD and X-AD of the data to be accessed by the executable program are input to the access permission/denial determination circuit 141, and it is determined whether access should be allowed to data to be accessed by the executable program to thereby output the access permission/denial signal ADS to the memory control circuit 555.

If the access permission/denial signal ADS denies the access to the security data to be accessed by the executable program, i.e., if it is determined that the access is an unauthorized access, the memory control circuit 555 outputs a memory erasing signal MES for erasing the security data to be accessed by the executable program. When the memory erasing signal MES is output, all bits of the security data stored in the memory are overwritten with “0” or “1”, thus altering the security data.

As described above, when there is an unauthorized access, the security data stored in the memory is altered to predetermined data, thus erasing the original security data itself to disable an access to the original security data. Therefore, it is possible to reliably protect memory data even if the unauthorized access is attempted repeatedly.

### Sixth Embodiment

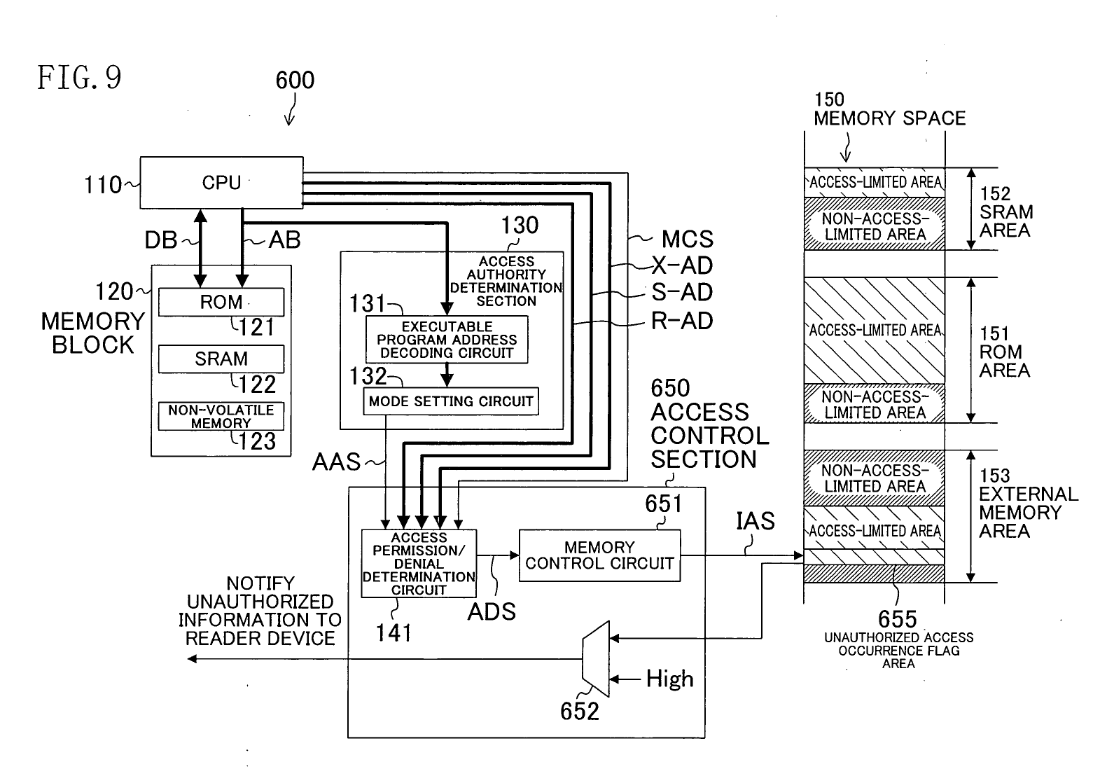

FIG. 9 is a block diagram showing a general configuration of a memory data protection device according to a sixth embodiment of the present invention.

Referring to FIG. 9, a memory data protection device 600 includes the CPU 110, the memory block 120, the access authority determination section 130 and an access control section 650. The memory block 120 includes the ROM 121, the SRAM (the memory) 122, and the non-volatile memory (the memory) 123. In the figure, R-AD is the logical address of data in the ROM 121, S-AD is the logical address of data in the SRAM 122, X-AD is the logical address of data in the non-volatile memory 123, and MCS is a memory control signal. Moreover, AB is a program address bus and DB is a program data bus, and the CPU 110 executes a program stored in the ROM 121 via the program address bus AB and the program data bus DB.

The access authority determination section 130 includes therein the executable program address decoding circuit 131 and the mode setting circuit 132. The access control section 650 includes therein the access permission/denial determination circuit (the access permission/denial determination section) 141, a memory control circuit 651, and a comparator (the unauthorized access notification section) 652. Moreover, an unauthorized access occurrence flag area (the unauthorized access storing section) 655 is provided in the access-limited area of the non-volatile memory 123.

The operation of the memory data protection device of the present embodiment will now be described.

When the CPU 110 is to execute a program in the ROM 121, the logical address of the executable program is input to the access authority determination section 130 via the program address bus AB.

In the access authority determination section 130, the executable program address decoding circuit 131 decodes the logical address of the executable program into the physical address of the executable program. Then, the decoded physical address of the executable program is input to the mode setting circuit 132, and it is determined whether the executable program is an API program with access authority to the security data in the memories 122 and 123 or an OS program without access authority, thus outputting the access authority signal AAS to the access control section 650.

In the access control section 650, the memory control signal MCS, the access authority signal AAS and the logical addresses R-AD, S-AD and X-AD of the data to be accessed by the executable program are input to the access permission/denial determination circuit 141, and it is determined whether access should be allowed to data to be accessed by the executable program to thereby output the access permission/denial signal ADS to the memory control circuit 651.

If the access permission/denial signal ADS denies the access to the security data to be accessed by the executable program, i.e., if it is determined that the access is an unauthorized access, the memory control circuit 651 outputs an unauthorized access signal IAS to the unauthorized access occurrence flag area 655 to thereby store the unauthorized access in the unauthorized access occurrence flag area 655. For example, if the unauthorized access occurrence flag area 655 normally holds a low value, a high value is written in the unauthorized access occurrence flag area 655 in response to the unauthorized access signal IAS.

The unauthorized access occurrence flag area 655 is provided in the access-limited area of the non-volatile memory 123 so that information therein will not be read out by an unauthorized access. A physical address being assigned to the unauthorized access occurrence flag area 655, and when there is an unauthorized access, the unauthorized access signal IAS is output from the memory control circuit 651 so that the particular physical address can be accessed, thereby allowing for the unauthorized access to be stored in the unauthorized access occurrence flag area 655.

When communicating with the outside, the low value or the high value written in the unauthorized access occurrence flag area 655 and a pre-input high value are input to the comparator 652. If the two inputs coincide with each other, the unauthorized access is notified to the outside. For example, the unauthorized access is notified to an external reader device, thereby disabling further communications.

As described above, when there is an unauthorized access, the unauthorized access is notified to the outside, thereby disabling the exchange of data between the memory data protection device and the outside to prohibit the reading out of the memory data. Therefore, it is possible to reliably control the access to security data and to protect the security data.

### Seventh Embodiment

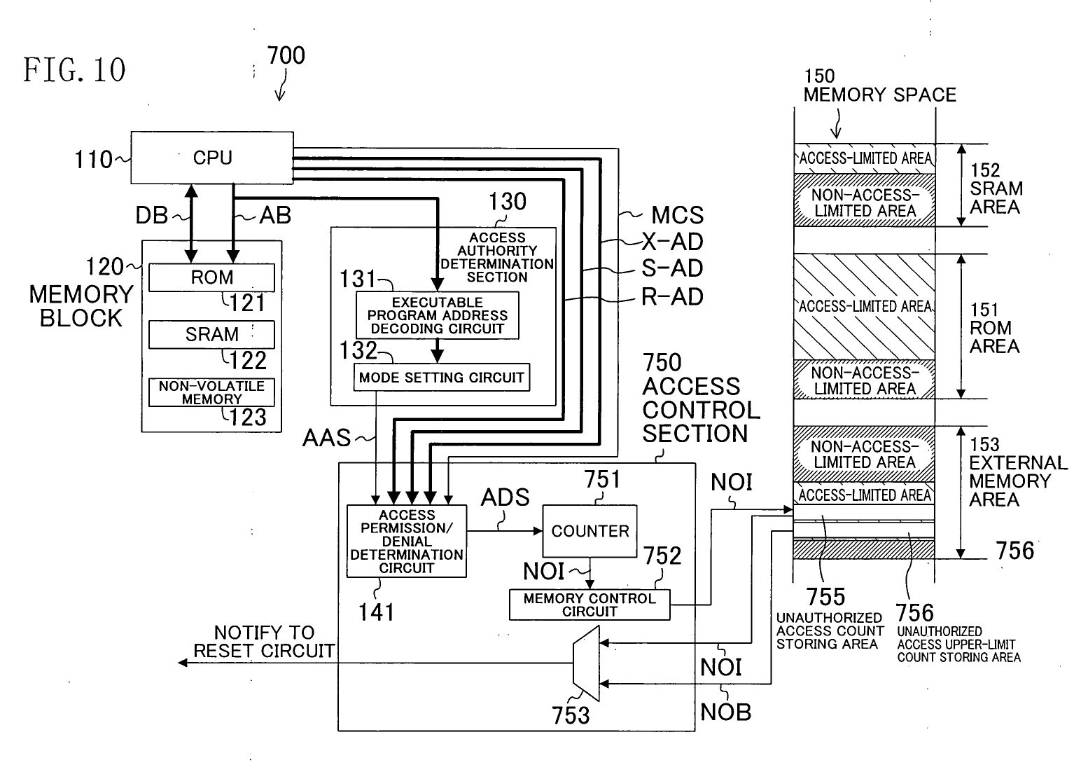

FIG. 10 is a block diagram showing a general configuration of a memory data protection device according to a seventh embodiment of the present invention.

A memory data protection device 700 of the present embodiment differs from the memory data protection device 600 of the sixth embodiment shown in FIG. 9 in that a counter circuit 751 is provided inside an access control section 750, and an unauthorized access count storing area 755 and an unauthorized access upper-limit count storing area 756 are provided inside the access-limited area of the non-volatile memory 123. Otherwise, the configuration is the same as that of the sixth embodiment, and will not be further described below.

The access permission/denial signal ADS output from the access permission/denial determination circuit 141 in the access control section 750 is input to the counter circuit 751, which keeps the unauthorized access count. The unauthorized access count NOI is output to a memory control circuit 752. The memory control circuit 752 outputs the unauthorized access count NOI to the unauthorized access count storing area 755 in the memory, and the unauthorized access count NOI is stored in the unauthorized access count storing area 755. The unauthorized access count NOI is a small number such that the security data or the location thereof cannot illicitly be identified by the unauthorized accesses.

The unauthorized access count storing area 755 is provided in the access-limited area. As in the sixth embodiment, when there is an unauthorized access, the memory control circuit 752 is controlled so that the physical address of the unauthorized access count storing section 755 can be accessed to store the unauthorized access count NOI.

When communicating with the outside, the unauthorized access count NOI and an unauthorized access upper-limit count NOB, which is preset in the unauthorized access upper-limit count storing area 756, are input to the comparator 753. If the unauthorized access count NOI is greater than or equal to the unauthorized access upper-limit count NOB (NOI≧NOB), the unauthorized access is notified to a reset circuit (not shown) to thereby reset the memory data protection device 700, thus disabling further operation.

As described above, when the unauthorized access occurs a number of times greater than or equal to the unauthorized access upper-limit count NOB, the operation of the memory data protection device 700 is reset to disable further operation, thereby disabling the exchange of data between the memory data protection device and the outside to prohibit the reading out of the memory data. Therefore, it is possible to reliably control the access to security data and to protect the security data.

Moreover, the unauthorized access upper-limit count NOB is set, and the memory data protection device 700 is not reset if the unauthorized access count is less than the unauthorized access upper-limit count NOB. Thus, it is possible to even better prevent an ill-willed person from identifying the location of the access-limited area storing the security data and to protect the security data from leakage.

The memory data protection devices of the first to seventh embodiments of the present invention can be used solely or in combination with one another to further improve the security. For example, one of the memory data protection devices of the first to fourth embodiments of the present invention can be combined with the memory data protection device of the seventh embodiment. Then, when there is an unauthorized access, the access is mapped to data different from the security data, and when the unauthorized access count becomes greater than or equal to the unauthorized access upper-limit count, the memory data protection device is reset to thereby disable further operation.

What is claimed is:

1. A memory data protection device for protecting security data in a memory from leakage for use in a semiconductor integrated circuit including:
the memory storing the security data;
a ROM storing a program with access authority to the security data in the memory and a program without the access authority; and
a CPU executing a program in the ROM, the memory data protection device comprising:
an access authority determination section for determining whether an executable program to be executed by the CPU is authorized to access the security data in the memory;
an access permission/denial determination section for determining whether the executable program can access the security data in the memory based on a determination result from the access authority determination section and a logical address of the data to be accessed by the executable program; and
a mapping changing section for changing mapping of the logical address of the security data to be accessed to an area in a memory space that is different from an area where the security data is stored, when the access to the security data in the memory by the executable program is denied by the access permission/denial determination section.

2. The memory data protection device of claim 1, wherein the security data in the memory is stored in an access-limited area to which an access is limited from a program without the access authority to the security data.

3. The memory data protection device of claim 2, wherein the mapping changing section changes the mapping of the logical address of the security data stored in the access-limited area of the memory to a physical address of data stored in a non-access-limited area outside the access-limited area.

4. The memory data protection device of claim 1, wherein:
an unauthorized access redirection area is provided in a memory space, and a physical address is assigned to the unauthorized access redirection area; and
the mapping changing section changes the mapping of the logical address of the security data stored in the memory to the physical address of the unauthorized access redirection area.

5. The memory data protection device of claim 1, wherein:
an unauthorized access redirection register is provided in a memory space, and a physical address is assigned to the unauthorized access redirection register; and
the mapping changing section changes the mapping of the logical address of the security data stored in the memory to the physical address of the unauthorized access redirection register.

6. The memory data protection device of claim 1, further comprising:
a wait circuit for delaying an output of a signal for a predetermined amount of time; and
a random number generating circuit for generating a random number of a predetermined bit width, wherein:
if the access to the security data in the memory by the executable program is a read operation access, the mapping changing section outputs to the CPU a random number generated by the random number generating circuit; and
if the access to the security data in the memory by the executable program is a write operation access, the mapping changing section outputs to the CPU an acknowledge signal delayed by the wait circuit according to a timing of a memory control signal output from the CPU.

7. The memory data protection device of claim 1, further comprising:
a wait circuit for delaying an output of a signal for a predetermined amount of time; and
a dummy data area in the ROM storing dummy data, wherein:
if the access to the security data in the memory by the executable program is a read operation access, the mapping changing section changes the mapping of the logical address of the security data stored in the memory to a physical address of the dummy data area to output to the CPU the dummy data in the dummy data area; and
if the access to the security data in the memory by the executable program is a write operation access, the mapping changing section outputs to the CPU an acknowledge signal delayed by the wait circuit according to a timing of a memory control signal output from the CPU.

8. A memory data protection device for protecting security data in a memory from leakage for use in a semiconductor integrated circuit including:
the memory storing the security data;
a ROM storing a program with access authority to the security data in the memory and a program without the access authority; and
a CPU executing a program in the ROM, the memory data protection device comprising:
an access authority determination section for determining whether an executable program to be executed by the CPU is authorized to access the security data in the memory;
an access permission/denial determination section for determining whether the executable program can access the security data in the memory based on a determination result from the access authority determination section and a logical address of the data to be accessed by the executable program; and
a data altering section for overwriting the security data to be accessed to predetermined data or erasing the security data to be accessed when the access to the security data in the memory by the executable program is denied by the access permission/denial determination section.

9. A memory data protection device for protecting security data in a memory from leakage for use in a semiconductor integrated circuit including:
the memory storing the security data;
a ROM storing a program with access authority to the security data in the memory and a program without the access authority;
a CPU executing a program in the ROM, the memory data protection device comprising:
an access authority determination section for determining whether an executable program to be executed by the CPU is authorized to access the security data in the memory;
an access permission/denial determination section for determining whether the executable program can access the security data in the memory based on a determination result from the access authority determination section and a logical address of the data to be accessed by the executable program;
an unauthorized access storing section for storing an unauthorized access when the access to the security data in the memory by the executable program is denied by the access permission/denial determination section; and
an unauthorized access notification section for notifying the unauthorized access stored in the unauthorized access storing section to outside.

10. The memory data protection device of claim 9, wherein:
the unauthorized access storing section is an unauthorized access count storing area provided in the memory; and
the unauthorized access notification section notifies the unauthorized access stored in the unauthorized access count storing area to outside when a comparison between an unauthorized access count stored in the unauthorized access count storing area with an unauthorized access upper-limit count stored in the memory indicates that the unauthorized access count is greater than or equal to the unauthorized access upper-limit count.

11. An IC card LSI provided in an IC card, comprising the memory data protection device of claim 1.

12. An IC card LSI provided in an IC card, comprising the memory data protection device of claim 8.

13. An IC card LSI provided in an IC card, comprising the memory data protection device of claim 9.
